(19) United States
(12) Patent Application Publication
(10) Pub. No.: US 2024/0009722 A1
(43) Pub. Date: Jan. 11, 2024

(54) HIGH-TEMPERATURE FORMING TOOL

(71) Applicant: PLANSEE SE, Reutte (AT)

(72) Inventors: Michael Androsch, Reutte (AT); Alexander Lorich, Reutte (AT); Michael Eidenberger-Schober, Reutte (AT); Robert Storf, Reutte (AT)

(21) Appl. No.: 18/252,917

(22) PCT Filed: Oct. 22, 2021
(86) PCT No.: PCT/AT2021/060393

§ 371 Date: May 15, 2023

(30) Foreign Application Priority Data
Nov. 13, 2020 (AT) GM50222/2020

(51) Int. Cl. B21B 25/00

(52) U.S. Cl. CPC B21B 25/00

(57) ABSTRACT

A high-temperature forming tool is formed at least partly of a molybdenum-based alloy having a fraction of molybdenum of ≥90 wt. %. The molybdenum-based alloy is in a pressed-and-sintered state and in the pressed-and-sintered state has a thermal shock resistance of at least 250 K. The thermal shock resistance is defined as the quotient of R_{eH}/(α·E), where R_{eH} is the yield point at room temperature in MPa, a is the thermal expansion coefficient in 1/K and E is the elasticity modulus in MPa.

The present invention relates to a high-temperature forming tool having the features of the preamble of claim 1 and to a process for producing a high-temperature forming tool, and also to use thereof.

High-temperature forming tools in the context of the present application refer to forming tools for the shaping of high-strength materials, such as high-alloy steels with high-temperature strength, for example.

The shaping takes place typically at temperatures of more than 1000° C., this being referred to as high temperature for the present application.

High-temperature forming tools in the context of this application include in particular the following: piercing plugs, of the kind used for producing seamless tubes; punches, of the kind used in flow moulding, for example and dies, of the kind used in the extrusion of metals, for example.

When a piercing plug is used, a heated billet is pulled over the piercing plug typically in a skewed-roller rotary piercing operation such as the Mannesmann process.

The piercing plug widens the inner diameter, smoothing it at the same time. The resultant thick-wall tube billet is drawn to a finished tube in downstream rolling steps.

When metals are flow-moulded, the punch displaces material in a workpiece; in the case of backwards flow moulding, shell sections of the punch also model a contour of the workpiece being produced.

When profiles are produced via extrusion, material is pressed for shaping through a shape-imparting die.

The collective loads on these high-temperature forming tools are similar. Requirements with regard to the material of which the high-temperature forming tool is made are, in particular, elevated high-temperature strength and resistance to thermal and corrosive attack.

Depending on the material of which the workpiece to be formed is made, blanks thereof (billets in the example of tube production) are brought for forming to temperatures up to 1300° C. Especially when processing high-alloy steels, and in spite of the elevated preheating, considerable forces are required for the forming operation (piercing of the billet in the example of tube production).

In addition, through friction and the forming work, large mechanical, thermal and abrasive/corrosive loads act on the high-temperature forming tool.

Even those high-temperature forming tools that are produced from steels with elevated high-temperature strength require cooling down between forming operations so as not to exceed a permissible service temperature of the material of which the high-temperature forming tool is made and so as to ensure sufficiently high strength of the high-temperature forming tool in service.

The general concern in the sector, therefore, is to employ high-temperature forming tools made from materials of further-enhanced high-temperature strength.

Accordingly, as well as high-alloy steels, alloys based on molybdenum are among materials to have been proposed for the production of high-temperature forming tools.

In the text below, the requirements with regard to the material for a high-temperature forming tool are discussed in more detail using a piercing plug as the example. The observations and conclusions are, however, also applicable to other high-temperature forming tools.

German patent DE102007037736 B4 describes, for example, a piercing plug and a plug rod made of a molybdenum material which has a molybdenum fraction of 75 wt. % or more, preferably of 80 wt. % or more, more preferably 85 wt. % or more and very preferably of 90 wt. % or more. With further preference, the molybdenum material proposed therein has a titanium fraction of 0.5 wt. % or more, a zirconium fraction of 0.08 wt. % or more and a carbon fraction of 0.01 to 0.04 wt. %.

This corresponds to the alloy specification of the molybdenum alloy known as “TZM”. By comparison with pure molybdenum, TZM is stronger and has a higher recrystallization temperature and also a higher creep strength.

The elevated high-temperature strength of the proposed molybdenum alloy allows the piercing plug to execute multiple piercings without having to be cooled in between. It is possible as a result to reduce further the cycle times, or, expressed alternatively, to carry out a greater number of piercings within a defined time.

Experiments by the applicant have shown that a further elevation in the high-temperature strength—as proposed in DE102007037736 B4—does indeed permit higher operating temperatures of the piercing plug, and yet is detrimental to product quality. In particular, the inner surface of tubes produced in this way may suffer thermal damage. Similar comments apply in respect of other high-temperature forming tools such as punches or dies.

It is an object of the present invention to specify an improved high-temperature forming tool. The intention in particular is that the high-temperature forming tool is economical to produce.

The object is achieved by a high-temperature forming tool having the features of claim 1.

It is proposed accordingly that the high-temperature forming tool consist at least partly of a molybdenum-based alloy having a fraction of molybdenum of 90 wt. %, the molybdenum-based alloy being in a pressed-and-sintered state and in the pressed-and-sintered state having a thermal shock resistance of at least 250 K, which thermal shock resistance is defined as the quotient of:

$$\frac{{R}_{e H}}{α \cdot E}$$

where R_{eH} is the yield point at room temperature in MPa, a is the thermal expansion coefficient in 1/K [Kelvin⁻¹] and E is the elasticity modulus in [MPa].

The yield point R_{eH} is ascertained in a tensile test according to standard DIN EN ISO 6892-1. The elasticity modulus E is determined according to DIN EN ISO 6892-1, Annex G.

The thermal expansion coefficient α is determined via dilatometer measurement.

The molybdenum-based alloy thus characterized forms a base material of the high-temperature forming tool.

With preference the high-temperature forming tool consists wholly of this molybdenum-based alloy.

Also conceivable are composites in which other materials are present in portions. In addition, of course, there may be a coating on the high-temperature forming tool.

The molybdenum-based alloy is produced by powder metallurgy (for short: “powder-metallurgical” molybdenum-based alloy) and therefore has a sintered microstructure. A sintered microstructure differs substantially, and in a way which is immediately apparent to the skilled person, from a cast microstructure. Features of a sintered microstructure, especially of the sintered microstructure of a molybdenum-based alloy, include a finer and more uniform grain structure relative to a cast microstructure. Generally speaking, a cast microstructure has fewer pores than a sintered microstructure. Relative to voids in a cast microstructure, the pores of a sintered microstructure are distributed uniformly.

A chemical homogeneity as well is better, generally speaking, in a powder-metallurgical material than in one produced by melt metallurgy. Particularly in the case of refractory metals, furthermore, the powder-metallurgical route is more economical. One of the reasons for this is that sintering takes place well below a melting temperature.

If it is not possible to determine the yield point R_{eH}, then the 0.2% offset yield, Rp_{0.2}, should be employed as a substitute variable. The 0.2% offset yield (i.e. stress with 0.2% plastic deformation) can be determined via a tensile test according to DIN EN ISO 6892-1.

The thermal shock resistance thus defined carries the unit Kelvin [K] and may be interpreted as a temperature difference which the material in question is able to withstand without damage. Damage here is rated as exceedance of the yield point.

Alternatively expressed, a temperature difference above this value leads to a permanent—plastic— deformation of the material.

It is even more favourable if the thermal shock resistance is above 260 K or even above 275 K. The material is then able to withstand even greater temperature gradients.

A high-temperature forming tool having the features according to the invention possesses extremely advantageous technological properties. For instance, a high-temperature forming tool of the invention can be cooled down particularly harshly without taking on damage. It has emerged that, in practice, the suitability of a high-temperature forming tool for intensive cooling is a vital factor if users wish to realize short cycle times between forming operations.

According to the prior art, high-temperature forming tools are produced from a semi-finished product obtained by rolling or forging, with the resulting microstructure in the prior art being a forming microstructure.

In contrast to this, the molybdenum-based alloy in accordance with the invention is in a pressed-and-sintered state. A microstructural state characterized as pressed and sintered is present if the material has undergone substantially no plastic shaping, and more particularly none at all. “Substantially” undeformed means here that no definitive shape-altering and/or cross section-altering forming has been imparted.

A slight surface forming, such as through a skin pass or sizing pass, smooth rolling, shot blasting or the like, for instance, is not considered to be a definitive shape-altering and/or cross section-altering forming operation.

Advantages of this include the amenability to economical production, since there is no need for mass forming or for any subsequent mechanical working.

With preference, the relative density of the base material of the high-temperature forming tool, i.e. of the molybdenum-based alloy, is between 90% and 97%, the porosity present being in other words between 3% and 10%. The relative density characterizes the ratio of the actual density of a substance under consideration by the nominal density of the corresponding material. In the example of pure molybdenum, the nominal density is 10.22 g/cm³. If a body made of molybdenum has a density of only 9.2 g/cm³, then the relative density is around 90% and the porosity 10%.

With particular preference, the relative density is between 91% and 96%, more preferably 94%±1%. The relative density is determined using the buoyancy method.

The substantially undeformed state is therefore marked by the presence of pores—in contrast to a formed state, such as by rolling or forging, for instance, where generally speaking the density is approximately 100%.

Particularly advantageous for the present utility is the grain growth-inhibiting effect of the pores. As a result, service at high temperatures is accompanied by no microstructure coarsening, or only to a low degree. Grain coarsening may have adverse consequences for the mechanical parameters that are relevant to the utility.

Whereas the usual approach in the prior art is to establish as high a density as possible, the present invention issues a different approach, and allows pores.

One way of describing the pressed-and-sintered state in relation to microstructural development is that there is no forming texture present. A forming texture marks a preferential crystallographic orientation of the grains that is caused by forming.

A forming texture is detectable on metallographic polished sections by means, for example, of EBSD measurements (electron backscatter diffraction).

Alternatively or additionally, the pressed-and-sintered microstructure state may be characterized by a grain aspect ratio (GAR). The grain aspect ratio may be expressed as a GAR value, with the GAR value indicating the ratio of a grain length to a grain width. A grain aspect ratio of more than 1 means that the grains have a greater extent in a lengthwise direction than transversely thereto. In other words, the grains then present are elongated.

With particular preference, in the case of the high-temperature forming tool, and to put it more precisely on the molybdenum-based alloy forming the high-temperature forming tool, there is a mean grain aspect ratio with a GAR value of less than 1.5, more particularly less than 1.2. A grain aspect ratio with a GAR value of 1 denotes an equal extent of the grains in a lengthwise direction and transversely thereto.

With particular preference, in the high-temperature forming tool, there is a grain aspect ratio with a GAR value of 1±10%, more favourably still a GAR value of 1±5%.

Forming—such as forging, for instance—would typically result in a grain aspect ratio with a GAR value of >1.5.

The GAR value is determined by image analysis on a metallographic sample, by the determination therein of a mean grain length and a mean grain width, with the GAR value resulting as the quotient of the mean grain length by the mean grain width. For determining the mean grain length and the mean grain width, respectively, an evaluation on at least 10 grains is favourable. The grain length is considered to be the extent of a grain in a lengthwise direction, and the grain width the extent of the grain transversely thereto.

Advantages of the presence of a pressed-and-sintered state are, in particular, isotropic microstructure properties and an amenability to economical production.

Isotropic microstructure properties mean that, in contrast to a forming microstructure, the properties present in the microstructure of a high-temperature forming tool of the invention are substantially the same in all spatial directions. This is particularly relevant with regard to the mechanical and also the thermophysical properties.

The production of the high-temperature forming tool in a pressed-and-sintered state is more favourable, furthermore, than production by forming, such as forging, for instance.

A basic shape of the high-temperature forming tool may be imposed on the pressed powder compact itself, this pressed powder compact also being particularly easy to work.

After sintering, only little afterworking, or none at all, is required, and so the high-temperature forming tool can be produced in net-shape or near-net-shape. A pressed-and-sintered state describes a microstructure state such as is established on production, in particular, by pressing and sintering, but may also be established, for example, through production via hot isostatic pressing (HIP) or hot pressing.

In powder metallurgy, pressing and sintering (for short: “p/s”) is the term used if a component is produced by pressing a powder or a powder mixture to give a green compact and subsequently sintering said compact, more particularly by unpressurized sintering. The powders may be pressed, for example, in a die or, for instance, cold isostatically in a rubber hose. This is the simplest and most favourable method for establishing a pressed-and-sintered state in a high-temperature forming tool of the present kind.

Contrary to the existing approaches to optimize the high-temperature forming tool in terms of its high-temperature strength, in other words to maximize the tensile strength at high temperatures, the present invention pursues a different path. Indeed, even if a high-temperature forming tool withstands particularly high service temperatures, the process becomes uneconomical if in the course of production the workpiece produced (a tube or a profile, for example) suffers damage—as has been shown by extensive technological tests by the applicant.

The invention is based on the finding that intensive cooling of the high-temperature forming tool is indispensable for economical implementation of the process. The surprising entry point of the applicant is that the definitive parameter for economical utilization of the advantages of molybdenum-based alloys is the capacity to withstand a temperature difference without damage—and not, for instance, a further raising of a high-temperature strength and/or of service temperatures.

A thermal shock resistance of greater than or equal to 250 K for the molybdenum-based alloy used makes it possible to cool the high-temperature forming tool intensively during the forming operation or between the forming operations, without damage occurring. In the example of a piercing plug, intensive cooling may take place between piercings and/or during a piercing. Accordingly, the fundamentally favourable property of an elevated high-temperature strength for molybdenum-based alloys can also be advantageously exploited from the standpoints of technology and economics.

The high-temperature forming tool preferably consists wholly of the molybdenum-based alloy having the above-defined features.

It is also conceivable to embody the high-temperature forming tool only partly from the molybdenum-based alloy having the above-defined features, in the exterior regions, for example, and to provide a conventional molybdenum alloy further into the interior.

The thermal shock resistance is a product of the above-described quotient incorporating the yield point. The yield point, therefore, is only one parameter among a plurality. With preference, the molybdenum-based alloy has a yield point R_{eH} at room temperature of at least 400 MPa. This development emphasizes the advantage of a high level of the yield point R_{eH} at room temperature.

If the yield point R_{eH} is not accessible, the 0.2% offset yield may be employed as a substitute.

Furthermore, it has proven to be extremely favourable for the utility of high-temperature forming tools if the high-temperature forming tool consists of a material which has an elongation at break (generally awarded the symbol “A”) in a tensile test at room temperature of at least 8%, preferably greater than 10%, more preferably greater than 15%.

The elongation at break A is ascertained in a tensile test according to standard DIN EN ISO 6892-1.

In service, this property means that the high-temperature forming tool, even after having undergone plastic strain, still has reserves before it fails due to fracture.

With preference, therefore, the molybdenum-based alloy which in accordance with the invention is in a pressed-and-sintered state has an elongation at break of at least 8%, preferably greater than 10%, more preferably greater than 15%.

With this, the advantages of the pressed-and-sintered state—such as the advantage of isotropy, for instance—become even more distinct and more utilizable.

For the technological properties, furthermore, it is advantageous if the base material of the high-temperature forming tool, i.e. the molybdenum-based alloy, has a plane-strain fracture toughness K_{IC} at room temperature of greater than or equal to 10 MPa M ½.

The plane-strain fracture toughness K_{IC} expresses the capacity of a material under crack stress, in other words after prior damage, to withstand mechanical load. The plane-strain fracture toughness K_{IC} is determined according to ASTM E 399.

Tests by the applicant have shown that this mechanical parameter is likewise relevant for the rough service conditions of a high-temperature forming tool. Particularly in the case of a sharply cooled-down high-temperature forming tool, which is subject to frequent sudden and/or impactful stresses, a sufficiently high plane-strain fracture toughness at room temperature is important.

With preference, the ductile-brittle transition temperature of the molybdenum-based alloy, ascertained in a flexural test, is 60° C.

With further preference the ductile-brittle transition temperature is 50° C., more particularly 40° C.

The ductile-brittle transition temperature (DBTT) marks a transition of the fracture mechanism in a material from a fracture behaviour with little energy absorption and/or elongation at break (i.e. a brittle behaviour in a material) to a fracture event with high energy absorption and/or elongation at break.

A low ductile-brittle transition temperature therefore denotes a docile—ductile—behaviour of a material even at low temperatures.

For the service conditions of a high-temperature forming tool, it has proven to be particularly advantageous if the ductile-brittle transition temperature is 60° C., more preferably 50° C., more particularly 40° C. In that case the high-temperature forming tool can be deployed even after uncontrolled and/or long water cooling without any substantial increase in the fracture risk, relative to a preheated state. This is important technologically and economically, since it means that cooling conditions do not have to be laboriously monitored, let alone regulated or controlled.

The ductile-brittle transition temperature is determined by performing three-point bending tests on samples at different temperatures. A flexing of the sample during fracture at a bending angle of 20° is employed for the purposes of this application as the stipulation of the ductile-brittle transition temperature. In other words, the base material proposed for the high-temperature forming tool achieves at least a bending angle of 20° at 60° C.

Investigations by the applicant have revealed that the desired mechanical and thermophysical features are achieved, for example, by a molybdenum-based alloy which has a molybdenum fraction of 99.0 wt. %, a boron fraction “B” of ≥3 ppmw (parts per million “weight”, i.e. weight-based ppm) and a carbon fraction “C” of ≥3 ppmw.

The investigations by the applicant have shown that with a microdoping of boron and carbon in the amounts indicated above, the high thermal shock resistance according to the invention in a pressed-and-sintered state is achieved.

The molybdenum-based alloy having a molybdenum fraction of ≥99.0 wt. %, a boron fraction “B” of ≥3 ppmw and a carbon fraction “C” of ≥3 ppmw, relative to conventional, powder-metallurgical, pure molybdenum (Mo), has a significantly increased ductility and also an increased offset yield Rp_{0.2}.

This is the case in particular by comparison with conventional molybdenum in the undeformed and/or (fully or partly) recrystallized state.

With further preference, the molybdenum-based alloy has a molybdenum fraction of ≥99.93 wt. %, a boron fraction “B” of ≥3 ppmw and a carbon fraction “C” of ≥3 ppmw.

With further preference, the total fraction “B+C” of carbon and boron is in the range of 15 ppmw≤“B+C” 50 ppmw, more particularly in the range of 25 ppmw≤“B+C”≤40 ppmw, and an oxygen fraction “O” is in the range of 3 ppmw≤“O”≤20 ppmw.

With further preference, the molybdenum-based alloy has a molybdenum fraction of ≥99.93 wt. %, a boron fraction “B” of ≥3 ppmw and a carbon fraction “C” of ≥3 ppmw, the total fraction (that is the sum total) of carbon and boron “B+C” being in the range of 15 ppmw≤“B+C”≤50 ppmw, more particularly in the range of 25 ppmw≤“B+C”≤40 ppmw, and an oxygen fraction “O” being in the range of 3 ppmw≤“O”≤20 ppmw.

In particular there is a maximum tungsten (W) content 330 ppmw.

In particular there is a maximum fraction of other impurities of 300 ppmw.

This expresses the fact that an even tighter monitoring of the chemical composition is favourable for the manifestation of the preferred mechano-technological properties.

The grain boundary strength of molybdenum is lowered in the region of the grain boundaries through segregation of oxygen and possibly of further elements, such as of nitrogen and phosphorus, for example.

Without plumping for a metallophysical explanation, it is assumed that the excellent properties of the proposed molybdenum-based alloy with high strength in combination with high ductility are established because of the contents of boron (B) and carbon (C) and, with further preference, the comparatively low oxygen (O) contents.

Also favourable is a combination with low maximum contents of other impurities and of tungsten (W).

It has been determined that even small contents of carbon and boron in combination lead to a significantly increased grain boundary strength and favourably influence the flow behaviour of the material (this behaviour being responsible for the high ductility) if at the same time the oxygen content is low and the content of other impurities (and W) is below the specified limiting values. Through the carbon fraction in particular it is possible to keep the oxygen fraction low in the molybdenum-based alloy.

In the case of the proposed low fractions of oxygen, of other impurities and of W, a low boron fraction in combination with a comparatively low carbon fraction is sufficient in itself to achieve the desired high thermal shock resistance and also high ductility values and strength values.

Chemical compositions indicated in this application should be understood to include the possibility of customary impurities being present.

In the case of figures which do not add up to 100%, the difference is formed by customary impurities.

The fractions of the various elements are determined via chemical analysis. In the chemical analysis, in particular, the fractions of most of the metallic elements (e.g. Al, Hf, Ti, K, Zr, etc.) are ascertained via the analytical method of ICP-MS (mass spectroscopy with inductively coupled plasma), the boron fraction is ascertained by the analytical method of ICP-MS (mass spectroscopy with inductively coupled plasma), the carbon fraction is ascertained via combustion analysis and the oxygen fraction is ascertained via hot extraction analysis (carrier-gas hot extraction).

According to one advantageous development, the boron fraction and the carbon fraction are each ≥5 ppmw. In the usual analytical methods, certified content data for boron and carbon can also be specified typically above 5 ppmw. In relation to low boron and carbon fractions, it should be noted that, while boron and carbon are also unambiguously detectable below a respective fraction of 5 ppmw, and their fractions are determinable quantitatively (at least provided that the respective fraction is ≥2 ppmw), the fractions within this range—depending on analytical method—can in some cases no longer be specified as certified values.

According to one development, the total fraction “B+C” of carbon and boron is in the range of 25 ppmw≤“B+C”≤40 ppmw.

According to one development, the boron fraction “B” is in the range of 5 ppmw “B”≤45 ppmw, more preferably in the range of 10 ppmw≤“B”≤40 ppmw.

According to one development, the carbon fraction “C” is in the range of 5 “C” ≤30 ppmw, more preferably in the range of 15≤“C”≤20 ppmw.

In these developments and especially in the case of the narrower range indications, the two elements (B, C) are present in an amount high enough and at the same time sufficient enough in the molybdenum-based alloy to make their advantageous interaction clearly perceptible, while at the same time the carbon present and the boron present do not have disadvantageous consequences for one another. In particular, the effect of carbon is to keep the oxygen fraction low in the molybdenum-based alloy, and that of boron is to enable a sufficiently low carbon fraction and at the same time to achieve a high ductility and a high strength.

According to one development, the oxygen fraction “O” is in the range of 5≤“O”≤15 ppmw. According to knowledge to date, the oxygen collects in the region of the grain boundaries (segregation) and leads to a lowering of the grain boundary strength. Correspondingly, an oxygen fraction low overall is advantageous. A low oxygen fraction of this kind is established both by the use of starting powders of low oxygen fraction (e.g. ≤600 ppmw, more particularly ≤500 ppmw), and by sintering under reduced pressure, under inert gas (e.g. argon) or preferably in a reducing atmosphere (more particularly in a hydrogen atmosphere or in an atmosphere with H2 partial pressure), and also by the provision of a sufficient carbon fraction in the starting powders.

1 According to one development, the maximum fraction of impurities by zirconium (Zr), hafnium (Hf), titanium (Ti), vanadium (V) and aluminium (Al) is in sum total≤50 ppmw. Preferably here the fraction of each element in this group (Zr, Hf, Ti, 4 V, Al) is in each case ≤15 ppmw. According to one development, the maximum fraction of impurities by silicon (Si), rhenium (Re) and potassium (K) is in sum total≤20 ppmw. Preferably here the fraction of each element in this group (Si, Re, K) is in each case ≤10 ppmw, more particularly ≤8 ppmw. The effect ascribed to potassium is that it lowers the grain boundary strength, and therefore the fraction desirable is as low as possible. Zr, Hf, Ti, Si and Al are oxide formers and could in principle be used to counteract accumulation of oxygen in the region of the grain boundaries, through binding of the oxygen (oxygen getters) and so in turn to increase the grain boundary strength. In part, however, they are suspected of lowering the ductility, especially if they are present in relatively large amounts. A ductilizing effect is ascribed to Re and V, meaning that they could in principle be used to increase the ductility. However, the addition of admixtures (elements/compounds) means that they can have disruptive consequences, depending on conditions of service.

According to one development, the molybdenum-based alloy has a total fraction of molybdenum and tungsten of ≥99.97 wt. %. A fraction of tungsten ≤330 ppmw is not critical for the stated utility and is present typically in any case through the recovery of Mo and powder production. The molybdenum-based alloy in particular has a molybdenum fraction of ≥99.97 wt. %, thus consisting almost exclusively of molybdenum.

According to one development, the carbon and the boron are present in sum total at not less than 70 wt. % based on the total content of carbon and boron, in dissolved form (that is, they do not form a separate phase). Investigations on the proposed molybdenum-based alloy have shown that there may be a small fraction of the boron that is present as Mo₂B phase, this phase being not critical at a low extent. If at least a high fraction (e.g. ≥70 wt. %, more particularly ≥90 wt. %) of the carbon and the boron is present in solution, then they are able to segregate to the grain boundaries and fulfil the above-elucidated effect to a particularly high degree. With preference, the stated limiting values are also observed by each of the elements B and C individually.

The features of the high thermal shock resistance of the molybdenum-based alloy in the pressed-and-sintered state may be achieved, as described above, via various combinations of microdoping elements, discussed using carbon and boron as an example.

In accordance with the stipulation of the establishment of a high ductility through high grain boundary strength, it is also possible to conceive of microdoping elements and combinations of microdoping elements other than carbon and boron.

The invention is therefore not confined necessarily to a molybdenum-based alloy with the discussed alloying strategy based on carbon and boron as microdoping elements. An alternative alloying strategy, for example, would be a ductilization through rhenium.

In one selected example, the molybdenum-based alloy forming the high-temperature forming tool exhibited typical characteristic material values as follows, for the pressed-and-sintered, and therefore undeformed, material at room temperature:

| | | | | Plane-strain |
|---|---|---|---|---|
| | | | | fracture |
| Density | Hardness | Yield point | Elongation at | toughness KIC |
| [g/cm³] | [HV10] | R_{eH} [MPa] | break A [%] | [MPa · m^{1/2}] |
| 9.4 | 145 | 400 | 10-30 | 23 |

The density of the molybdenum-based alloy forming the high-temperature forming tool here was around 9.4 g/cm³, corresponding to a relative density of around 92%, with density of molybdenum of 10.2 g/cm³. The contents of carbon and boron were in each case around 15 μg/g. The content of molybdenum was around 99.97 wt. %. Typical impurities make the sum up to 100%.

The elasticity modulus scales with the relative density and was determined as being around 305 000 MPa.

The thermal expansion coefficient α of the molybdenum-based alloy was 5.2×10⁻⁶[K⁻¹].

On the selected example, a thermal shock resistance was determined, defined as the quotient of:

$$\frac{{R}_{e H}}{α \cdot E}$$

where R_{eH} is the yield point at room temperature in MPa, α is the thermal expansion coefficient in 1/K [Kelvin⁻¹] and E is the elasticity modulus in [MPa], of around 252 K.

The high-temperature forming tool is embodied in particular as a piercing plug. In tests by the applicant it has emerged that the properties of the above-defined molybdenum-based alloy are manifested with particular advantage in the case of application to a piercing plug.

Protection is also sought for the use of a high-temperature forming tool according to any of the preceding claims for producing tubes or profiles, more particularly from high-strength metals, more particularly from high-alloy steels.

The utility of a forming tool having the above-specified properties has proved to be particularly useful in industrial tube production. The property profile according to the invention is of particular advantage especially in the case of piercings of high-alloy steels in a (skewed-roller) rotary piercing process. In the production of profiles via extrusion, the use of a die according to any of the preceding claims is particularly advantageous, since the profile of properties is applicable to this high-temperature forming operation as well. Where a high-temperature forming tool of the invention is used, the user is able to experience in particular the advantages of the robustness and also the economy of the high-temperature forming tool.

Protection is also sought for a process for producing the high-temperature forming tool.

Molybdenum-based alloys for the industrial scale are processed to components typically by way of powder-metallurgical routes. For refractory metals, generally speaking, melt metallurgy is impracticable and/or uneconomic.

Usually a powder or a powder mixture is compressed to a green compact, then sintered, and subsequently formed into a semi-finished product by rolling, forging and the like. In a deviation from this customary production route, the high-temperature forming tool is produced in accordance with the invention without, or substantially without, plastic shaping.

The process for producing the high-temperature forming tool is characterized by steps as follows:
a. pressing of a powder mixture of molybdenum powder and boron- and carbon-containing powders, to give a green compact;
b. optional working of the green compact for approximation to a final shape of the piercing plug;
c. sintering of the green compact in an oxidation-proof atmosphere with a residence time of at least 45 minutes at temperatures in the range of 1600° C.-2200° C., to afford a sintered blank of the high-temperature forming tool;
d. optional final working of the sintered blank to give the finished high-temperature forming tool, in this case the piercing plug.

The advantages elucidated above in relation to the molybdenum-based alloy are achieved correspondingly via the above-stated process for producing a high-temperature forming tool. Furthermore, corresponding developments, of the kind elucidated above, are also possible with the process.

For the production of the discussed molybdenum-based alloy microdoped with boron and/or carbon, in the case of boron- and carbon-containing powders, the powders in question may be molybdenum powder containing a corresponding boron and/or carbon fraction. It is important here that the starting powder which is used for pressing the green compact contains sufficient amounts of boron and carbon and that these admixtures are distributed extremely uniformly and finely in the starting powder.

The sintering step in particular comprises a heat treatment for a residence time of 45 minutes up to 12 hours (h), preferably of 1-5 h, at temperatures in the range of 1800° C.-2100° C. The sintering step is carried out in particular under reduced pressure, under inert gas (e.g. argon) or, preferably, in a reducing atmosphere (more particularly in a hydrogen atmosphere or in an atmosphere with H2 partial pressure).

As already observed, the production of a high-temperature forming tool having the properties according to the invention such as the thermal shock resistance in the pressed-and-sintered state is not necessarily confined to a molybdenum-based alloy with the discussed alloying strategy based on the microdoping elements carbon and boron. The process claim, instead, indicates one particularly advantageous and economic pathway.

In accordance with the stipulation of the establishment of a high ductility through high grain boundary strength, it is also possible to conceive of microdoping elements and combinations of microdoping elements other than carbon and boron, or a different alloying strategy.

Further advantages and expediencies of the invention are apparent from the description below of exemplary embodiments with reference to the appended figures.

Of the figures:

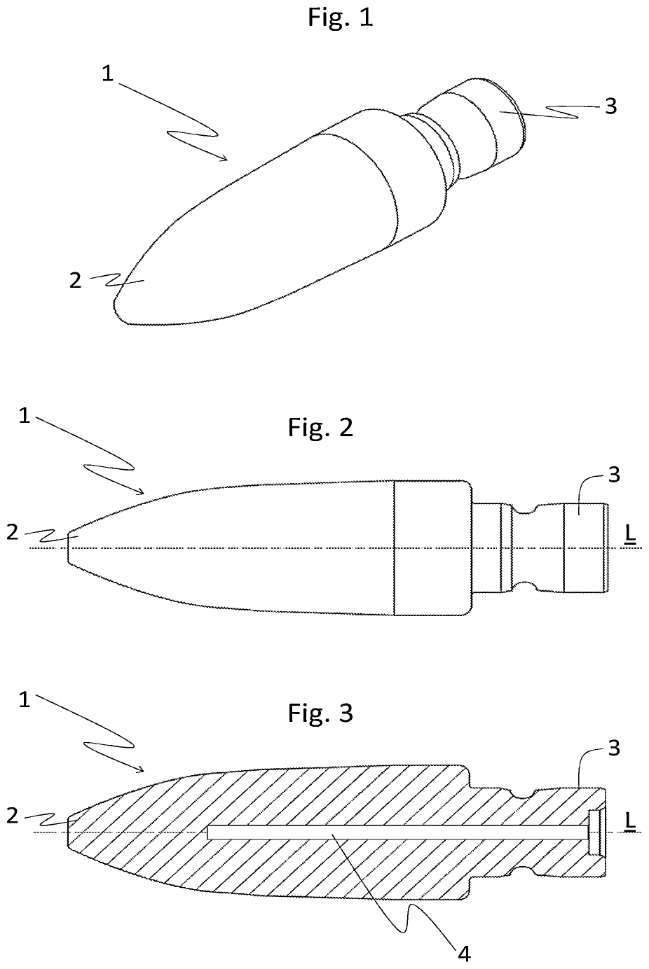

FIG. 1: shows a perspective view of an exemplary embodiment of a high-temperature forming tool—piercing plug as example

FIG. 2: shows a side view of a piercing plug

FIG. 3: shows a piercing plug in cross section

FIGS. 4a, 4b show views of a further exemplary embodiment of a high-temperature forming tool—die as example

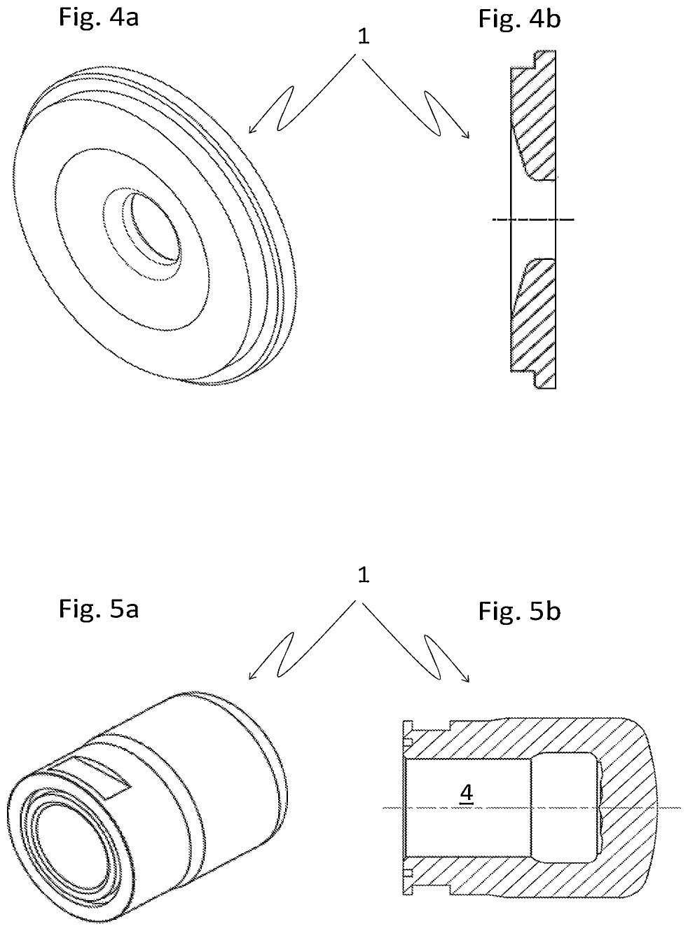

FIGS. 5a, 5b show views of a further exemplary embodiment of a high-temperature forming tool—punch as example

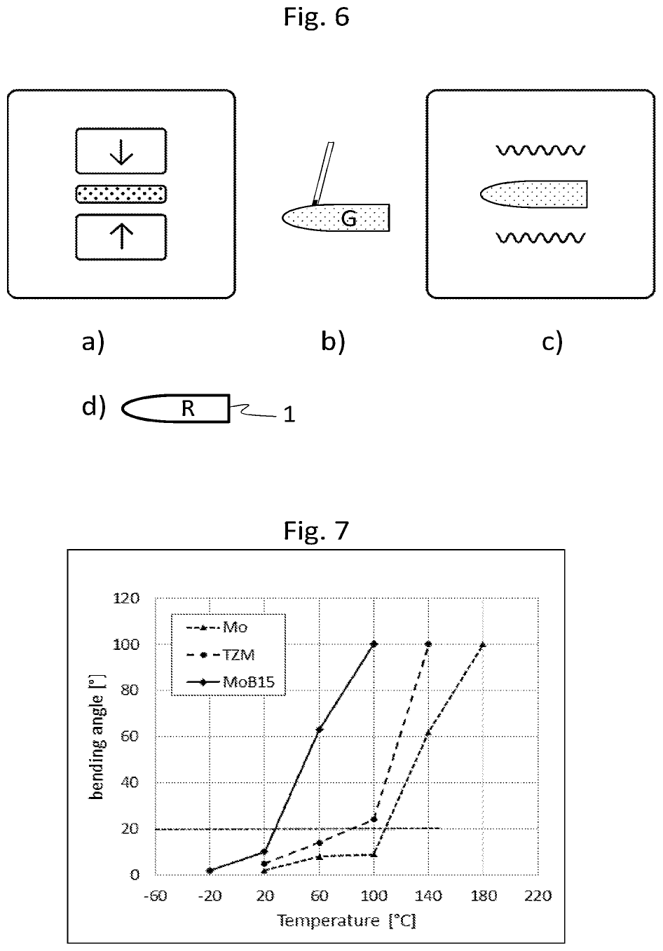

FIG. 6 shows schematically the production route for a high-temperature forming tool, using a piercing plug as example

FIG. 7 shows a diagram relating to the ductile-brittle transition temperature

FIG. 8 shows a scanning electron micrograph of a Mo material according to the prior art

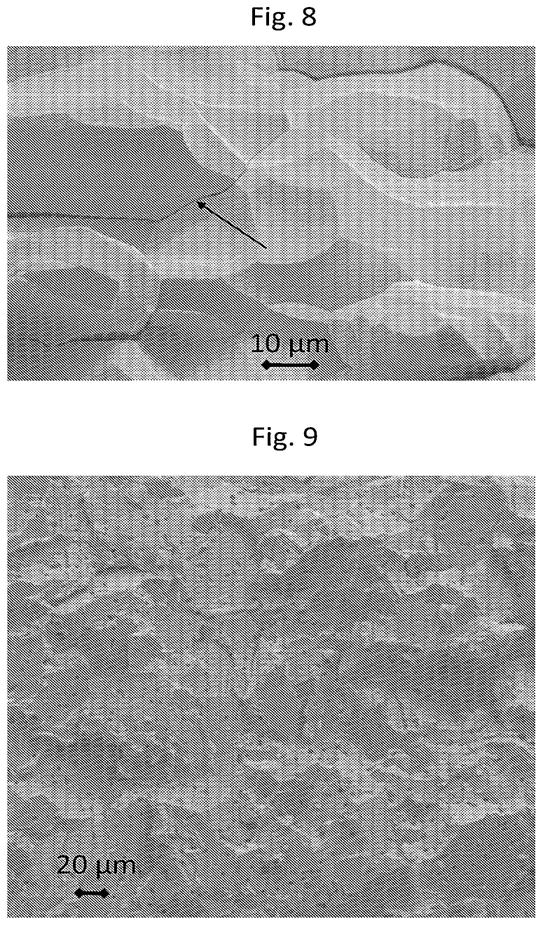

FIG. 9 shows a scanning electron micrograph of a molybdenum-based alloy of a high-temperature forming tool of the invention

FIG. 1 shows schematically a high-temperature forming tool of the invention, which in this exemplary embodiment is embodied as a piercing plug 1. The piercing plug 1 has a tip portion 2 and a rear portion 3. At the rear portion 3, the piercing plug 1 is typically carried by a plug rod (not shown), for which a receiver is embodied.

The same is also evident from FIG. 2, which shows the piercing plug 1 in a side view. In the exemplary embodiment, the piercing plug 1 is implemented as rotationally symmetrical with respect to an axis of symmetry L.

FIG. 3 shows the piercing plug 1 in a cross section. Represented here is an optional facility 4 for cooling and/or instrumentation of the piercing plug 1. In the example, the facility 4 is implemented as a drilled hole.

FIGS. 4a and 4b show views of a further exemplary embodiment for a high-temperature forming tool of the invention, here, as an example, of a die 1 for metal forming. FIG. 4a here shows a perspective view, FIG. 4b a cross section.

Dies of the kind shown here are employed, for example, in the extrusion of high-alloy steels. Naturally, the die 1 may take on different shapes and, in particular, different cross-sectional shapes.

FIGS. 5a and 5b show views of a further exemplary embodiment for a high-temperature forming tool of the invention, here, as an example, of a punch 1 for metal forming. FIG. 5a here shows a perspective view, FIG. 5b a cross section. A facility 4 may be embodied for introducing a cooling medium. In the present example, the facility 4 is also configured as a receiver.

Punches of the kind shown here are employed, for example, in the backwards flow moulding of high-alloy steels. Naturally, the punches may also take on shapes which differ from the shape shown here.

FIG. 6 shows schematically the production route for a high-temperature forming tool of the invention, in the example of a piercing plug 1. In step a), a powder mixture of molybdenum powder and boron- and carbon-containing powders is compressed to give a green compact G.

The optional step b) shows the working of the green compact G for approximation to a final shape of the piercing plug 1.

In step c), the green compact G is sintered, to afford a sintered blank R of the piercing plug 1.

After the sintering, in step d), the piercing plug 1 is obtained through the sintered blank R. There may optionally be working of the sintered blank R.

FIG. 7 shows a diagram relating to the ductile-brittle transition temperature for various materials which are in principle candidates for high-temperature forming tools.

The variables plotted are bending angles in [° ] of three-point bending samples as the x-axis, against the temperature in [° C.] as the y-axis. The bending angles indicate the plastic bending of the sample at the onset of fracture.

In this diagram, the right-hand curve (dotted, labelled “Mo”) marks a typical profile of the fracture behaviour of pure molybdenum in the pressed-and-sintered state. It is seen that the material exhibits a pronounced ductile behaviour only beyond about ≥140° C.

Somewhat more favourable is the profile of the middle curve (dashed, labelled “TZM”), which shows the profile of the ductile-brittle transition for TZM in the pressed-and-sintered state. The profile is shifted slightly towards lower temperatures, which characterizes a somewhat more docile behaviour.

The two right-hand profiles (“Mo” and “TZM”) correspond to the prior art.

The left-hand curve (solid, labelled “MoB15”) shows a typical profile of a ductile-brittle transition for a molybdenum-based alloy of the kind which is proposed as particularly preferred for a high-temperature forming tool and has a molybdenum fraction of ≥99.0 wt. %, a boron fraction “B” of 3 ppmw and a carbon fraction “C” of ≥3 ppmw.

The advantages are achieved as soon as, according to one development, the base material of the high-temperature forming tool has a ductile-brittle transition temperature of ≤60° C. In the example presently shown, the ductile-brittle transition temperature, defined by plastic bending of 20° bending angle, is in fact well below 60° C., specifically around 30° C.

Also drawn in is an auxiliary line at a bending angle of 20°. Bending of the sample on fracture at a bending angle of 20° is employed in the context of this application as the stipulation of the ductile-brittle transition temperature. Where the plastic bending experienced is ≥20°, it is possible for technological purposes to assume a ductile behaviour of the material. Test parameters employed in the three-point bending test were as follows: an initial force of 20 N [newtons], a test velocity of 10 mm/min, a supporting width of 20 mm. The radius of the bearing rollers was 1.5 mm, as was the radius of the bending punch. The sample dimensions were 6×6×35 mm.

FIG. 8 shows a scanning electron micrograph of a molybdenum material according to the prior art. The molybdenum material is in a recrystallized state. The micrograph shows a fracture surface of a tensile sample tested at room temperature. A striking feature is the presence of what is called an intercrystalline fracture, referring to a fracture with predominant separation of material along grain boundaries. A grain boundary detachment of this kind is marked by way of the inserted arrow. In the case of such an intercrystalline fracture event, the ductility is determined by the grain boundary strength.

FIG. 9 shows a fracture face of a molybdenum-based alloy of the kind suitable and proposed preferentially for the production of a piercing plug of the invention. The alloying strategy is based on an improvement in the grain boundary strength and is achieved in particular if the molybdenum-based alloy has a molybdenum fraction of ≥99.0 wt. %, a boron fraction “B” of ≥3 ppmw and a carbon fraction “C” of ≥3 ppmw. The fracture event here is transcrystalline, meaning that a fracture runs through the grains. This fracture event is due to a substantially increased grain boundary strength and is associated macroscopically with a substantially higher ductility.

1-15. (canceled)

16. A high-temperature forming tool, comprising:
a body being formed at least partly of a molybdenum-based alloy having a fraction of molybdenum of ≥90 wt. %, said molybdenum-based alloy being in a pressed-and-sintered state and in the pressed-and-sintered state having a thermal shock resistance of at least 250 K, the thermal shock resistance being defined as a quotient of R_{eH}/(α·E), where R_{eH} is a yield point at room temperature in MPa, α is a thermal expansion coefficient in 1/K and E is an elasticity modulus in MPa.

17. The high-temperature forming tool according to claim 16, wherein said molybdenum-based alloy has the yield point R_{eH} at room temperature of at least 400 MPa.

18. The high-temperature forming tool according to claim 16, wherein said molybdenum-based alloy has a relative density of between 90% and 97%.

19. The high-temperature forming tool according to claim 16, wherein said molybdenum-based alloy has an elongation at break at room temperature of at least 8%.

20. The high-temperature forming tool according to claim 16, wherein said molybdenum-based alloy has a plane-strain fracture toughness K_{IC} at room temperature of greater than or equal to 10 MPa·m^{1/2}.

21. The high-temperature forming tool according to claim 16, wherein a ductile-brittle transition temperature of said molybdenum-based alloy, ascertained in a bending test, is ≤60° C.

22. The high-temperature forming tool according to claim 16, wherein said molybdenum-based alloy has said fraction of molybdenum being ≥99.0 wt. %, a boron fraction “B” of ≥3 ppmw and a carbon fraction “C” of ≥3 ppmw.

23. The high-temperature forming tool according to claim 22, wherein said molybdenum-based alloy has said fraction of molybdenum being ≥99.93 wt. %, said boron fraction “B” being ≥3 ppmw and said carbon fraction “C” being ≥3 ppmw, a total fraction “B+C” of said carbon and said boron being in a range of 15 ppmw≤“B+C”≤50 ppmw.

24. The high-temperature forming tool according to claim 22, wherein said molybdenum-based alloy has an oxygen fraction “O” is in a range of 3 ppmw≤“O”≤20 ppmw.

25. The high-temperature forming tool according to claim 22, wherein said molybdenum-based alloy has said fraction of molybdenum being ≥99.93 wt. %, said boron fraction “B” being ≥3 ppmw and said carbon fraction “C” being≥3 ppmw, a total fraction “B+C” of said carbon and said boron being in a range of 15 ppmw≤“B+C”≤50 ppmw and an oxygen fraction “O” being in a range of 3 ppmw≤“O”≤20 ppmw.

26. The high-temperature forming tool according to claim 16, wherein said molybdenum-based alloy has a mean grain aspect ratio, expressed as GAR value, formed as quotient of a grain length by a grain width, of less than 1.5.

27. The high-temperature forming tool according to claim 16, wherein said body is formed wholly of said molybdenum-based alloy.

28. The high-temperature forming tool according to claim 16, wherein said body has embodied therein at least one facility for introducing a cooling medium.

29. A method for producing a product, which comprises the steps of:
providing a high-temperature forming tool according to claim 16; and
using the high-temperature forming tool for producing tubes or profiles.

30. A process for producing a high-temperature forming tool, which comprises the following steps of:
pressing of a powder mixture of molybdenum powder and boron- and carbon-containing powders, to give a green compact; and
sintering the green compact an oxidation-proof atmosphere with a residence time of at least 45 minutes at temperatures in a range of 1600° C.-2200° C., to afford a sintered blank of the high-temperature forming tool.

31. The process for producing the high-temperature forming tool according to claim 30, which comprises:
working the green compact for approximation to a final shape of the high-temperature forming tool; and
final working of the sintered blank.
